(19) United States
(12) Patent Application Publication
(10) Pub. No.: US 2026/0084377 A1
(43) Pub. Date: Mar. 26, 2026

(54) AN ADDITIVE MANUFACTURING APPARATUS FOR ADDITIVELY MANUFACTURING A THREE-DIMENSIONAL OBJECT BY CURING A PHOTOCURABLE RESIN

(71) Applicant: AXTRA3D Inc., Dover, DE (US)

(72) Inventors: GIANNI ZITELLI, Vicenza (IT); FEDERICO IACOVELLA, Vicenza (IT)

(73) Assignee: AXTRA3D Inc., Dover, DE (US)

(21) Appl. No.: 19/109,782

(22) PCT Filed: Nov. 11, 2022
(86) PCT No.: PCT/EP2022/081578

§ 371 Date: Mar. 7, 2025

(51) Int. Cl. B29C 64/321; B29C 64/124; B29C 64/314; B29C 64/35; B29C 64/393; B33Y 30/00; B33Y 40/10; B33Y 50/02

(52) U.S. Cl. CPC B29C 64/321; B29C 64/124; B29C 64/314; B29C 64/35; B29C 64/393; B33Y 30/00; B33Y 40/10; B33Y 50/02

(57) ABSTRACT

An additive manufacturing apparatus for additively manufacturing a three-dimensional object by curing a photocurable resin, comprising:
a vat device delimiting a vat volume for receiving a photocurable resin;
a build platform device comprising a build platform being moveably supported relative to the vat device in at least one degree of freedom of motion;
at least one irradiation device configured to emit electromagnetic radiation to selectively and successively cure the or a resin provided in the vat volume to additively manufacture a three-dimensional object;
a resin supply device, the resin supply device configured to supply photocurable resin from at least one resin container to the vat device, the resin supply device comprising:
at least one resin container delimiting a container volume for receiving a photocurable resin, and
at least one resin conveying device configured to convey photocurable resin from the container volume to the vat device.

The invention relates to an additive manufacturing apparatus for additively manufacturing a three-dimensional object by curing a photocurable resin.

Respective additive manufacturing apparatuses are generally known from the prior art and are configured for additively manufacturing a three-dimensional object by photocuring a photocurable resin via electromagnetic radiation. The base configuration of respective apparatuses typically, comprises a vat device delimiting a vat volume for receiving a photocurable resin, a build platform device comprising a build platform moveably supported relative to the vat device in at least one degree of freedom of motion, and an irradiation device, e.g. a digital light projector device, configured to emit electromagnetic radiation to selectively and successively cure the photocurable resin provided in the vat volume to additively manufacture a three-dimensional object in a build direction. The basic operation of respective apparatuses is well-known and needs no further explanation.

While respective apparatuses have been continuously improved and provide satisfactory quality of the printed three-dimensional objects, there still remain challenges which respect to a practical handling of a photocurable resin which is to be processed within a respective apparatus. Specifically, no satisfactory suggestions have been made to realize a suitable resin circuit within a respective apparatus which could form the basis for implementing an internal resin recirculation and/or resin recycling.

Hence, there exists a need for a further improved additive manufacturing apparatus for additively manufacturing a three-dimensional object by photocuring a photocurable resin.

It is therefore, an object of the present invention to provide an improved additive manufacturing apparatus for additively manufacturing a three-dimensional object by photocuring a photocurable resin.

The object is particularly achieved by the subject-matter of the appended Claims.

A first aspect of the invention relates to an additive manufacturing apparatus (“apparatus”) for additively manufacturing a three-dimensional object by photocuring a photocurable resin. The apparatus is thus, generally configured to additively manufacture a three-dimensional object by photocuring a photocurable resin. Curing a photocurable resin typically, comprises a successive layerwise selective irradiation of the photocurable resin with electromagnetic energy (light) emitted form at least one irradiation device to successively generate cured resin layers of the three-dimensional object to be additively manufactured, wherein each cured resin layer represents a cross-section of the three-dimensional object to be additively manufactured.

The apparatus comprises a vat device. The vat device delimits a vat volume (receiving volume) for receiving a photocurable resin. A respective photocurable resin can be a polyamide resin, for instance. The vat device can comprise one or more vat device elements. One or more vat device elements form one or more walls of the vat device which are arranged and/or oriented to delimit the vat volume for receiving the photocurable resin.

The bottom of the vat device or the bottom of the vat volume of the vat device, respectively can be built by a or comprise at least one membrane. The membrane can be attachable or attached to one or more vat device elements of the vat device. The membrane is typically, transmissive to electromagnetic radiation (light) emitted from the at least one irradiation device of the apparatus. The membrane thus, has transmissive properties at least with respect to the electromagnetic radiation emitted from the at least one irradiation device of the apparatus. The membrane can thus, be transparent (at least with respect to the properties, e.g. wavelength, of the electromagnetic radiation emitted from the at least one irradiation device of the apparatus). The membrane typically, has a plane base shape. The membrane is typically, elastic and/or flexible. The membrane can thus, exhibit a reversible deflection and/or deformation behavior upon exertion of forces, such as pressure forces, during operation of the apparatus. Respective forces can directly or indirectly result from a motion of a build platform of the apparatus relative to the membrane. The membrane can thus, be reversibly deflected and/or deformed with respect to a zero state upon exertion of respective forces. Hence, the membrane can be built of an elastic and/or flexible material or of an elastic and/or flexible material structure enabling the respective reversible deflection and/or deformation behavior. A respective elastic and/or flexible material can be a polymer material and a respective elastic and/or flexible material structure can be a polymer material structure, for instance.

The apparatus further comprises a build platform device. The build platform device comprises a build platform. The build platform defines a build surface on which a three-dimensional object can be additively manufactured. The build surface typically, comprises a plane surface facing the bottom of the vat device or vat volume of the vat device, respectively. The build platform is moveably supported relative to the vat device, particularly the membrane, in at least one degree of freedom of motion. The at least one degree of freedom of motion is typically, a translatory freedom of motion along a translatory axis. The translatory axis is typically, arranged and oriented, respectively perpendicular relative to a base plane of the bottom of the vat device or vat volume of the vat device, respectively. The build platform device can comprise one or more actuators, such as one or more electromotors, configured to effect motions of the build platform relative to the vat device along the translatory axis. The one or more actuators can be particularly, configured to effect reciprocal motions of the build platform along the translatory axis; the build platform can thus, be moved in two directions, e.g. upward and downward, along the translatory axis. The build platform is typically, arranged above the membrane. The apparatus can thus, have a so-called bottom-up configuration. However, at least some of the aspects or features of the apparatus specified in the following could also be implemented in so-called top-down configuration. As such, the apparatus can also have a so-called top-down configuration.

The apparatus further comprises at least one irradiation device, such as e.g. a digital light projector device, configured to emit electromagnetic radiation (light) to selectively and successively cure the or a resin provided in the vat volume to additively manufacture a three-dimensional object. The wavelength of the electromagnetic radiation emitted by the at least one irradiation device is typically chosen with respect to the photocuring behavior of the photocurable resin to be processed with the apparatus. As an example, the wavelength of the of the electromagnetic radiation emitted by the at least one irradiation device can be in a range between 375 nm and 425 nm, particularly in a range between 385 nm and 415 nm, more particularly in a range between 395 and 405 nm.

The at least one irradiation device is typically, arranged below the vat device. The same applies when the apparatus comprises at least two different irradiation devices.

In exemplary embodiments, the apparatus can comprise at least two different irradiation devices. In an exemplary configuration of the apparatus with at least two different irradiation devices, a first irradiation device can be or comprise a digital light projector device and a second irradiation device can be or comprise a laser device. The at least two different irradiation devices can be configured to emit electromagnetic radiation of (substantially) the same wavelength or of similar wavelength. Similar wavelength can mean that the wavelength of the respective electromagnetic radiation differs no more than 10%, particularly no more than 5%, from each other. The apparatus can comprise one or more optical devices assigned to the one or more irradiation devices. Respective optical devices can be arranged in the optical path between the one or more irradiation devices and the membrane. Respective optical devices can comprise at least one of: a beam combining device, a collimating device, an expanding device, a focusing device, a polarizing device, a beam splitting device, etc.

The apparatus further comprises a resin supply device configured to supply photocurable resin from at least one resin container to the vat device. The resin supply device thus, generally provides a fluid connection, e.g. implemented via at least one resin supply line, between at least one resin container and the vat device which fluid connection at least enables that photocurable resin can be conveyed from at least one resin container to the vat device. Thus, the resin supply device typically, comprises at least one resin supply line between at least one resin container and the vat device. A respective resin supply line can be built by or comprise a hose, tube, or pipe, for instance. Particularly, a respective resin supply line can be built by or comprise a flexible hose, tube, or pipe. A respective resin supply line can be provided with nozzle elements at their respective free ends, particularly the free ends assigned to the vat device.

The resin supply device thus, forms basis for implementing a resin supply system within the apparatus which can implement an internal resin recirculation and/or resin recycling. As will be apparent from further below, the resin supply device can thus, form the basis for implementing a resin supply cycle or loop, particularly a closed resin supply cycle or loop, within the apparatus.

The resin supply device comprises at least one resin container. The at least one resin container delimits a container volume for receiving a photocurable resin. The resin container can comprise one or more walls, e.g. one or more bottom walls, one or more side walls, one or more top walls, which commonly delimit the container volume. If the resin container comprises two or more wall elements, the wall elements are connected with each other so as to do delimit the container volume. The connection of the wall elements can be a chemically and/or physically connection which can be achieved via, e.g. via clamping, screwing, riveting, gluing, soldering, welding, etc. One or more seal elements can be provided between adjacent wall elements to avoid the possibility of leakage of photocurable resin out of the container volume.

At least one wall or wall element, respectively of the resin container can be moveably supported relative to at least one other wall element so as to be transferred in an open state in which access into the container volume is possible, and in a close state, in which no access into the container volume is possible. Hence, at least one wall element can be built as or comprise a lid element which enables eased filling or de-filling of the container volume with a liquid, such as a photocurable resin or a cleaning agent.

The one or more walls of the resin container can be made from metal or plastic, for instance. Also, composite materials, such as fiber composite materials, are conceivable. The one or more walls of the resin container can at least partially be provided, e.g. via coating, spraying, etc., with one or more passivation layers configured to avoid possible (undesired) chemical and/or physical interactions between the one or more wall elements and a photocurable resin inside the container volume.

As an example, the resin container can have a rotationally symmetric base shape. As such, the resin container can have a (hollow) cylindrical base shape, for instance. The resin container can thus, have a bottle- or tank-like configuration, for instance. However, other basic shapes of the resin container are generally contemplated.

As an example, the container volume of the resin container can be a volume of at least one of: 0.1 l, 0.2 l, 0.3 l, 0.4 l, 0.5 l, 0.6 l, 0.7 l, 0.8 l, 0.9 l, 1.0 l, 1.1 l, 1.2 l, 1.3 l, 1.4 l, 1.5 l, 1.6 l, 1.7 l, 1.8 l, 1.9 l, 2.0 l, 2.1 l, 2.2 l, 2.3 l, 2.4 l, 2.5 l, 2.6 l, 2.7 l, 2.8 l, 2.9 l, 3.0 l, 3.1 l, 3.2 l, 3.3 l, 3.4 l, 3.5 l, 3.6 l, 3.7 l, 3.8 l, 3.9 l, 4.0 l, 4.1 l, 4.2 l, 4.3 l, 4.4 l, 4.5 l, 4.6 l, 4.7 l, 4.8 l, 4.9 l, or 5.0 l, for instance.

The resin supply device further comprises at least one resin conveying device. The at least one resin conveying device is configured to convey photocurable resin from the container volume to the vat device. The at least one resin conveying device is thus, generally configured to convey photocurable resin from the at least one resin container to the vat device. Particularly, the at least one resin conveying device is configured to convey photocurable resin out of the container volume, into at least one resin supply line extending between the at least one resin container and the vat device, and out of the at least one resin supply line into the vat volume of the vat device. As such, the at least one resin conveying device is configured to generate a stream of photocurable resin from the at least one resin container to the vat device. Particularly, the at least one resin conveying device is configured to generate a stream of photocurable resin out of the container volume of the at least one resin container, into at least one resin supply line extending between the at least one resin container and the vat device, through the at least one resin supply line, out of the at least one resin supply line, and into the vat volume of the vat device.

Operation of the at least one resin conveying device thus, particularly comprises generating a respective stream of photocurable resin from the at least one resin container into the vat volume of the vat device. Operation of the at least one resin conveying device can be controlled by a hardware- and/or software-implemented control unit which is configured to generate control information for controlling operation of the at least one resin conveying device. Controlling operation of the at least one resin conveying device can particularly, comprise controlling operational parameters of the at least one resin conveying device, such as conveying power, which influence the amount of photocurable resin, particularly the amount of photocurable resin per time, which is to be conveyed from the at least one resin container to the vat device. Controlling operation of the at least one resin conveying device can be based on sensor information, e.g. indicative of a filling level or state of the vat device, which are provided by one or more sensors of the apparatus. As such, operation of the at least one resin conveying device can be implemented as a control loop.

The at least one resin conveying device can be built as or comprise at least one pump device. A respective pump device can be a peristaltic pump device, for instance. A peristaltic pump device, which can also be referred to as “roller pump”, is a positive displacement pump for conveying the photocurable resin contained in a respective resin supply line showing elastic and/or flexible behavior. The resin supply line can be fitted inside a casing of the peristaltic pump which also comprises at least one rotor device having a number of rotor elements, such as rollers, attached to its external circumference. During operation of the peristaltic pump, the rotor elements compress the resin supply line as they rotate which generates a compression resulting in a conveying motion of the photocurable resin through the resin supply line. Hence, the photocurable resin will not be in chemical and/or physical contact with any component of the peristaltic pump such that the risk of contamination of the photocurable resin is reduced.

By providing the apparatus with a respective resin supply device, a practical handling of a photocurable resin which is to be processed within the apparatus is given. Specifically, providing the apparatus with a respective resin supply device enables realizing a suitable resin circuit within a respective apparatus which, as will be apparent from further below, can form the basis for implementing an internal resin recirculation and/or resin recycling within the apparatus.

As will be apparent from further below, the vat device and the at least one resin container can be arranged in at least two different chambers or portions of a frame structure of the apparatus. The frame structure can comprise one or more frame structure elements and/or one or more wall elements. As an example, the frame structure of the apparatus can define a first chamber or first portion and at least one second chamber or second portion. The first chamber or first portion can be separated from the second chamber or second chamber by at least one wall element. The respective wall element can comprise a receiving portion for receiving the vat device. At least the build platform device and/or the vat device can be arranged in the first chamber or first portion. The first chamber or first portion of the frame structure of the apparatus can also be deemed an upper chamber or upper portion of the frame structure or apparatus, respectively. At least the at least one irradiation device can be arranged in the second chamber or second portion. The second chamber or second portion of the frame structure of the apparatus can also be deemed a lower chamber or lower portion of the frame structure or apparatus, respectively.

Notably, also the at least one resin container can be arranged in the second chamber or second portion. As such, a respective resin supply line can extend between a respective first chamber or portion and a respective second chamber or portion to provide a fluid connection between the at least one resin container arranged in the second chamber or second portion and the vat device arranged in the first chamber or first portion. Hence, the frame structure of the apparatus can be provided with one or more passage structures, e.g. channels, openings, for at least one resin supply line which facilitates that the at least one resin supply line can extend between the respective second chamber or second portion and the respective first chamber or first portion, or vice versa, to provide at least one fluid connection between the at least one resin container and the vat device, or vice versa.

The frame structure of the apparatus can comprise attachment interfaces enabling a stable attachment of functional units of the apparatus, such as e.g. the vat device, the build platform device, the at least one irradiation device. The frame structure can thus, be deemed a machine frame of the apparatus.

The frame structure can comprise one or more frame structure elements and/or wall elements arranged in one or more spatial directions and/or spatial planes so as to define an internal space of the apparatus. Particularly, the one or more frame structure elements and/or wall elements are arranged in one or more spatial directions and/or spatial planes so as to divide the internal space of the apparatus into respective chambers or portions such as the first chamber or first portion and the respective second chamber or second portion as specified above.

As indicated above, the at least one resin container and/or the at least one resin conveying device can be arranged within the internal space of the apparatus as defined by the frame structure. Particularly, the at least one resin container and/or the at least one resin conveying device can be arranged in a respective second chamber or second portion as specified above such that any possible undesired interaction between curing processes within the process chamber and the at least one resin container and/or the at least one resin conveying device can be avoided. Particularly, the at least one resin container and/or the at least one resin conveying device can be arranged in a respective second chamber or second portion in a hanging or standing arrangement.

The frame structure can thus, comprise one or more attachment interfaces e.g. for attaching the at least one resin container and/or the at least one resin conveying device to the frame structure. Respective attachment interfaces can particularly, be provided with respective frame structure elements delimiting a respective second chamber or second portion as specified above or with wall elements delimiting a respective second chamber or second portion.

Respective attachment interfaces can enable a detachable attachment of the at least one resin container and/or the at least one resin conveying device. Hence, attachment of at least one of the at least one resin container and/or the at least one resin conveying device can be detachable so as to facilitate an exchange of the at least one resin container and/or the at least one resin conveying device, e.g. for service- and/or maintenance purposes.

The apparatus can further comprise an agitating device configured to agitate the photocurable resin provided in the container volume of the at least one resin container. As such, photocurable resin in the container volume of the at least one resin container can be agitated. Agitating the photocurable resin in the container volume of the at least one resin container can e.g. avoid possible undesired sagging and/or segregation effects of different chemical compounds of the photocurable resin. In other words, agitating the photocurable resin in the container volume of the at least one resin container can maintain and/or improve the properties of the photocurable resin throughout one or more build processes.

The agitating device can comprise at least one agitating element arranged in the container volume of the at least one resin container. The at least one agitating element can be moveable supported in at least one degree of freedom of motion to create an agitating motion. The agitating motion can also be deemed a stirring motion. The at least one degree of freedom of motion of the at least one agitating element can be a translational degree of freedom of motion along a translational axis, which can be a central or symmetry axis of the at least one resin container. Alternatively or additionally, the at least one degree of freedom of motion of the at least one agitating element can be a rotational degree of freedom of motion about a rotational axis, which can be a central or symmetry axis of the at least one resin container. Also, combined motions of the at least one agitating element in at least two different degrees of freedom of motion, e.g. in one or more translational degrees of freedom of motion and/or in one or more rotational degrees of freedom of motion, are conceivable.

The at least one agitating element can generally have a longitudinal basic shape. Particularly, the at least one agitating element can have a blade- or blade-like shape. A respective blade- or blade-like shape can comprise one or more effective agitating surfaces which result in an agitation of the photocurable resin when the at least one agitating element is in the agitating motion.

The dimensions of the at least one agitating element can generally be adapted to the dimensions of the container volume of the at least one resin container. As an example, the container volume can have specific cross-sectional dimensions, particularly a specific cross-sectional width. The longitudinal dimensions of the at least one agitating element can be chosen under consideration of the specific cross-sectional dimensions of the container volume. As an example, the longitudinal dimensions of the at least one agitating element can be at least 30%, particularly at least 40%, more particularly at least 50%, more particularly at least 60%, more particularly at least 70%, more particularly at least 80%, more particularly at least 90% of the specific cross-sectional dimensions of the container volume. In other words, the at least one agitating element can occupy a significant amount of the specific cross-sectional dimensions of the container volume which results in a highly effective agitating, particularly avoiding or at least reducing dead zones.

In case of multiple agitating elements, one or more first agitating elements can have a first shape and/or first dimensions and one or more second agitating elements can have a second shape and/or second dimensions, wherein the first and the second shape and/or dimensions can be the same or different.

In case of multiple agitating elements, the agitating device can comprise a carrier structure, such as a carrier rod, which comprises attachment interfaces for attaching one or more agitating elements thereto in one or more orientations and/or vertical positions. Multiple agitating elements can thus, be arranged in a (vertically) stacked arrangement in different (vertical) planes, wherein at least one agitating element is arranged in each plane.

In case of multiple agitating elements, one or more first agitating elements can be moveable supported in at least one first degree of freedom of motion and one or more second agitating elements can be moveable supported in at least one second degree of freedom of motion, wherein the first and the second degree of freedom of motion can be the same or different.

The apparatus can further comprise at least one drive device couplable or coupled with the at least one agitating element to exert a drive force and/or drive momentum on the at least one agitating element so as to create a motion, particularly the agitating motion, of the at least one agitating element in the at least one degree of freedom of motion. The at least one drive device can be built as or comprise at least one electric motor, such as a servomotor, for instance.

Operation of the at least one drive device can be controlled by a hardware- and/or software-implemented control unit which is configured to generate control information for controlling operation of the at least one drive device. Controlling operation of the at least one drive device can particularly, comprise controlling operational parameters of the at least one drive device, such as drive power, which influence the intensity of the agitating motion, particularly the speed of the agitating motion per time, of the at least one agitating element. Controlling operation of the at least one drive device can be based on sensor information, e.g. indicative of an agitating state or level of the photocurable resin, which are provided by one or more sensors of the apparatus. As such, operation of the at least one drive device can be implemented as a control loop.

Notably, the at least one drive device can be external to the at least one resin container and being couplable or coupled with the at least one agitating element via at least one coupling device. As such, the at least one drive device can be a separate unit relative to the at least one resin container. In such a manner, the constructive and/or functional configuration of the at least one resin container can be kept relatively simply because an integration of a drive device is not (necessarily) required.

The at least one coupling device can comprise at least one first coupling element operably coupled with the at least one drive device and at least one second coupling element operably coupled with the at least one agitating element. The at least one first coupling element and the at least one second coupling element can be coupled, e.g. via corresponding engagement structures, such as thread structures, so as to transfer the drive force created by the at least one drive device to the at least one agitating element.

The at least one first coupling element can be provided in a bottom region of the frame structure of the apparatus. Particularly, the at least one first coupling element can be provided in a bottom region of a respective second chamber or second portion of the frame structure. Likewise, the at least one second coupling element can be provided with a bottom region of the at least one resin container. Such an arrangement of the at least one first and second coupling element can not only ease coupling of the at least one first coupling element with the at least one second coupling element because the coupling can simply be achieved by arranging the at least one resin container in the bottom region of the frame structure above the at least one first coupling element, but also facilitates a highly integrated arrangement of the at least one resin container within the frame structure of the apparatus.

The apparatus can comprise one or more dampening elements arranged between the at least one resin container and the frame structure. Respective dampening elements can be configured to dampen vibrations possibly caused by agitating motions of the at least one agitating element. Dampening respective vibrations can be of advantage because respective vibrations cannot negatively affect e.g. the operation the at least one irradiation device which typically comprises several sensitive optical elements, such as lenses, for instance.

The apparatus can comprise a tempering device configured to temper photocurable resin in the container volume and/or photocurable resin in at least resin supply line connecting the at least one resin container, particularly the container volume, with the vat device. The tempering device can particularly, be configured to temper photocurable resin in the container volume and/or photocurable resin in at least resin supply line with respect to a specific viscosity of the photocurable resin and thus, with respect to a specific conveying and/or processing behavior of the photocurable resin. As such, tempering of the photocurable resin via the tempering device can generally comprise both cooling and/or heating the photocurable resin. As will be apparent from further below, the tempering device can generally be configured to enable a conductive and/or convective tempering of photocurable resin in the container volume, for instance.

Operation of the at least one tempering device can be controlled by a hardware- and/or software-implemented control unit which is configured to generate control information for controlling operation of the at least one tempering device. Controlling operation of the at least one tempering device can particularly, comprise controlling operational parameters of the at least one tempering device, such as tempering power, which influence the amount of thermal energy provided to the photocurable resin. Controlling operation of the at least one tempering device can be based on sensor information, e.g. indicative of a temperature or a viscosity of the photocurable resin, which are provided by one or more sensors of the apparatus. As such, operation of the at least one tempering device can be implemented as a control loop.

The tempering device can comprise at least one tempering element arranged outside the at least one resin container, the at least one tempering element being configured to emit electromagnetic radiation, e.g. radio-frequency radiation, into the container volume of the at least one resin container and/or into an inner volume of the at least one resin supply line. Tempering of the photocurable resin can thus, be effected via electromagnetic radiation. As such, a respective tempering element can comprise at least one emitter of electromagnetic radiation, particularly electromagnetic radiation of specific properties, e.g. a specific wavelength, which can be chosen under consideration of the absorption properties of the photocurable resin to be tempered. Notably, the specific properties of the electromagnetic radiation are chosen such that only tempering and no curing of the photocurable resin is effected.

Additionally or alternatively, the tempering device can comprise at least one tempering channel structure arranged at or in at least one wall element of the at least one resin container, wherein the at least one tempering channel structure is configured to receive a flow of at least one tempering medium. A respective tempering channel structure can comprise one or more tempering channels extending in one or more spatial directions and/or spatial planes. As such, one or more wall elements of the at least one resin container can be tempered by having a tempering medium, e.g. a cooled or heated fluid, stream through the tempering channel structure arranged at or in at least one wall element of the at least one resin container. In such a manner, a conductive and convective tempering of the photocurable resin is possible which avoids any direct contact between the tempering medium and the photocurable resin.

The same principles can apply to the wall elements of a respective resin supply line. As such, the tempering device can comprise at least one tempering channel structure arranged at or in at least one wall element of the at least one resin supply line, wherein the at least one tempering channel structure is configured to receive a flow of at least one respective tempering medium.

The apparatus can further comprise at least one filtering device configured to filter particulate elements, e.g. impurities, residues, etc., within the resin from a flow of resin flowing out of the at least one resin container and/or from a flow of resin flowing into the at least one resin container. The filtering device can comprise at least one selectively permeable wall, e.g. made from a material or a material structure, e.g. made from or polyethylene, which is non-reactive with the photocurable resin. The material can comprise openings, e.g. of a size between 50-200 μm, for instance. The filtering device can particularly, be configured to filter particulate elements from the photocurable resin before they enter the vat device and/or the container volume such that a specific degree of purity of the photocurable resin can be maintained. The filtering device can be an active filtering device, i.e. a filtering device having an actively controllable filtering activity, and/or a passive filtering device, i.e. a filtering device having no actively controllable filtering activity.

Operation of at least one active filtering device can be controlled by a hardware- and/or software-implemented control unit which is configured to generate control information for controlling operation of the at least one active filtering device. Controlling operation of the at least one active filtering device can particularly, comprise controlling operational parameters of the at least one active filtering device, such as filtering power, which influence the filtering efficiency. Controlling operation of the at least one active filtering device can be based on sensor information, e.g. indicative of a degree of undesired residues in the photocurable resin, which are provided by one or more sensors of the apparatus. As such, operation of the at least one active filtering device can be implemented as a control loop.

The at least one filtering device can comprise at least one filtering element, e.g. a screening or sieving element, arranged in the at least one resin container and/or in at least one connecting element connecting the at least one resin container with the vat device. The at least one filtering element can enable a chemical and/or physical filtering of respective undesired residues from the photocurable resin. As such, the at least one filtering element can comprise a chemical and/or physical interfaces which are configured to hinder undesired residues from passing through the at least one filtering element, for instance. Respective chemical and/or physical interfaces can be provided as or with respective openings as indicated above.

It has been indicated above that the resin supply device forms basis for implementing a resin supply system within the apparatus which can implement an internal resin recirculation and/or resin recycling. Particularly, it has been indicated above that the resin supply device can form the basis for implementing a resin supply cycle or loop, particularly a closed resin supply cycle or loop, within the apparatus.

A respective closed resin supply cycle or loop, which particularly facilitates internal resin recirculation and/or resin recycling, can at least comprise the at least one resin container, the vat device, at least one first resin supply line connecting the at least one resin container with the vat device, and at least one second resin supply line connecting the vat device with the at least one resin container. In a respective configuration, the at least one first resin supply line and/or the at least one second resin supply line can be provided with at least one resin conveying device.

As such, the at least one resin container can comprise at least one outlet portion for connecting a first resin supply line to enable a flow of photocurable resin flowing from the at least one resin container into the vat device. A respective outlet portion can be provided with a wall element, particularly with a top wall element or with a side wall element, of the at least one resin container. A respective outlet portion can be built as or comprise a connecting socket allowing a, particularly fluid-tight, connection of the at least one resin container with a respective first resin supply line.

The at least one outlet portion can be connected with at least one internal suction element, preferably arranged within an effective region of the or at least one agitating element, for removing photocurable resin out of the container volume of the at least one resin container. The at least one internal suction element can be moveably supported within the container volume of the at least one resin container so as to remove photocurable resin from different locations inside the container volume of the at least one resin container. The at least one internal suction element can be built as or comprise a suction nozzle element, for instance.

Alternatively or additionally, the at least one resin container can comprise at least one inlet portion for connecting a second resin supply line to enable a flow of photocurable resin flowing from the vat device into the resin container. A respective inlet portion can be provided with a wall element, particularly with a top wall element or with a side wall element, of the at least one resin container. A respective inlet portion can be built as or comprise an inlet connecting socket allowing a, particularly fluid-tight, connection of the at least one resin container with a respective second resin supply line.

The at least one outlet portion and/or the at least one inlet portion can be provided with a detachable wall element of the at least one resin container which detachable wall element is detachably attachable or attached to at least one other wall element of the at least one resin container. A respective detachable wall element can be built as or comprise a lid element of the at least one resin container. Providing the at least one outlet portion and/or the at least one inlet portion with a lid element of the at least one resin container can improve installation and handling, for instance.

As mentioned before, a first resin conveying device assigned to the first resin supply line to generate a flow of photocurable resin flowing out of the at least one resin container into the vat device, and a second resin conveying device assigned to the second resin supply line so as to generate a flow of photocurable resin flowing out of the vat device into the at least one resin container can be provided. Hence, generating a first flow of photocurable resin from the at least one resin container to the vat device having first flowing properties, e.g. flowing velocity, and generating a second flow of photocurable resin from the vat device to the at least one resin container having second flowing properties, e.g. flowing velocity, is possible. The first and second flowing properties can be same or different such that a high degree of freedom with respect to filling and/or de-filling of the at least one resin container and/or the vat device is possible, for instance.

As mentioned before, the apparatus can comprise a hardware- and/or software-implemented control unit configured to control operation of the at least one resin conveying device. The control unit can be particularly, configured to control operation of the at least one resin conveying device, particularly a first resin conveying device assigned to a respective first resin supply line, so as to implement a first resin conveying mode in which photocurable resin is supplied from the at least one resin container to the vat device. Further, the control unit can be configured to control operation of at least one resin conveying device, particularly a second resin conveying device assigned to a respective second resin supply line, so as to implement a second resin conveying mode in which photocurable resin is supplied from the vat device to the at least one resin container. As such, a recirculation of photocurable resin within the apparatus can be facilitated by a concerted control of respective first and/or second resin conveying devices.

Further, the control unit can be configured to control operation of the at least one resin conveying device so as to implement a cleaning mode in which a cleaning agent, e.g. a cleaning fluid comprising alcohol, is supplied from the at least one resin container to the vat device and/or vice versa. As such, the configuration of the apparatus also facilitates an improved cleaning of the apparatus, particularly to remove photocurable resin from the apparatus, which can e.g. be required when the apparatus is to be operated with chemically different photocurable resins. Notably, the resin supply system of the apparatus as specified above cannot only be used for conveying a photocurable resin within the apparatus but also for conveying a cleaning agent within the apparatus. Conveying a cleaning agent within the apparatus can thus, result in that not only the vat device but also other components comprised by the resin cycle or loop can be cleaned in automatable or automated manner.

The apparatus can also comprise at least one cleaning station for cleaning the at least one resin container and/or the vat device. The cleaning station can at least comprise a cleaning agent supply and at least one cleaning agent conveying device configured to convey a cleaning agent into the container volume of the at least one resin container and/or into the vat volume of the vat device. The cleaning station may comprise a frame structure which may be connected with the frame structure of the apparatus such that a functionally highly integrated configuration of the apparatus is given. Alternatively, the frame structure of the cleaning station can be separate to the frame structure of the apparatus which enables to freely arrange the cleaning station independent from the apparatus.

In exemplary embodiments, the resin supply device can comprise two or more resin containers. In a configuration with two or more resin containers, the resin supply device can comprise at least one resin distribution device which is configured to selectively connect the at least one of the resin containers with the vat device such that a fluid connection between the at least one other resin container and the vat device is established, while at least one other resin container is not connected with the vat device such that no fluid connection between the at least one other resin container and the vat device is established.

The at least one resin distribution device can comprise one or more resin distribution elements which are configured to selectively establish a connection of at least one resin container of the multiple resin containers with the vat device such that a fluid connection between the at least one resin container of the multiple resin containers and the vat device is established. A respective resin distribution element can be built as or comprise a control valve element, for instance. A respective control valve element can be transferred in an open state in which a fluid connection between at least one resin container and the vat device is established, and in a closed state in which a fluid connection between the at least one resin container and the vat device is not established. A respective control valve element can be particularly, configured as a directional control valve element which enables selectively establishing a fluid connection of one specific resin container of the plurality of resin containers with the vat device.

Operation of the at least one resin distribution device and respective resin distribution elements, can be hardware- and/or software-implemented control unit which is configured to generate control information for controlling operation of the at least one resin distribution device. Controlling operation of the at least one resin distribution device can particularly, comprise controlling transferring respective valve elements in their respective open or closed states so as to selectively establish fluid connections between specific resin containers and the vat device.

In further exemplary embodiments, the apparatus can be provided with a fill-level indicating device configured to provide an information indicative of a fill-level of photocurable resin in the container volume of at least one resin container. A respective fill-level indicating device can comprise one or more fill-level sensors configured to determine the fill-level of a photocurable resin in the container volume of at least one resin container. Respective fill-level sensors can be provided internal or external to the at least one respective resin container. Respective fill-level sensors can be built as or comprise acoustic sensors, electrical sensors, such as capacitive sensors, optical sensors, mechanical sensors, such as weight sensors, for instance.

In further exemplary embodiments, the at least one resin container can be provided with an information carrier, such as a barcode, QR-code, etc., which contains information about the photocurable resin received in the container volume. Respective information can thus, be machine-readable information. Respective information can comprise current or future chemical and/or physical properties of the photocurable resin, for instance. Chemical and/or physical properties can thus, not only include the chemical composition and related material properties, such as viscosity, etc. of the respective photocurable resin but also to processing conditions, such as curing wavelength, etc.

A second aspect of the invention relates to a method of operating an additive manufacturing apparatus according to the first aspect of the invention. The method at least comprises a step of conveying, via at least one resin conveying device, a photocurable resin and/or a cleaning agent from the at least one resin container into the vat device and/or from the vat device into the at least one resin container.

The method can be particularly, implemented by a control of respective controllable devices of the apparatus via respective assigned control units as specified above.

All annotations concerning the apparatus of the first aspect of the invention also apply to the method of the second aspect of the invention and vice versa.

The disclosure will also be readily understood by the following description of exemplary embodiments in conjunction with the accompanying drawings in which:

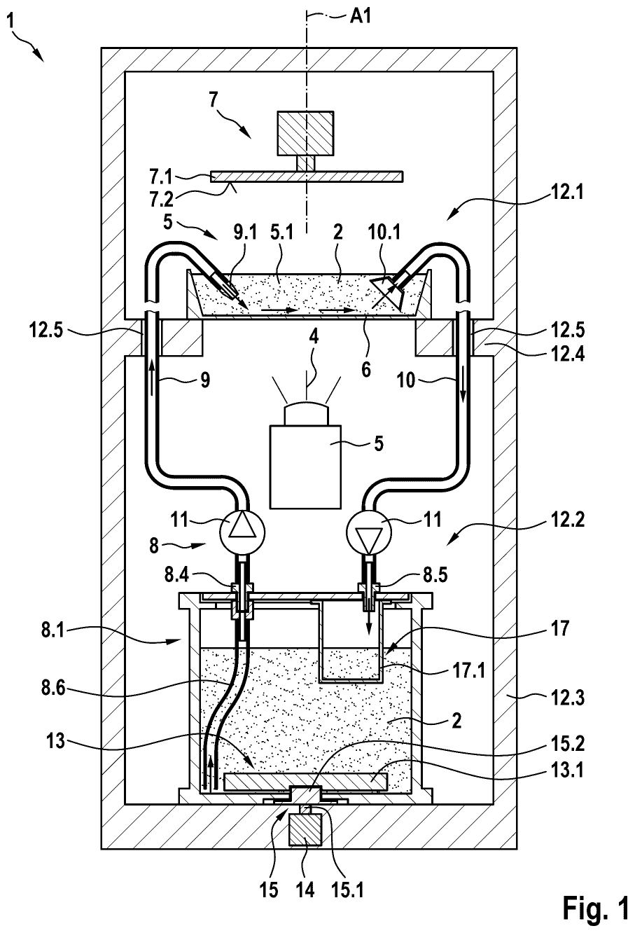

FIG. 1 illustrates a principle drawing of an additive manufacturing apparatus in accordance with an exemplary embodiment;

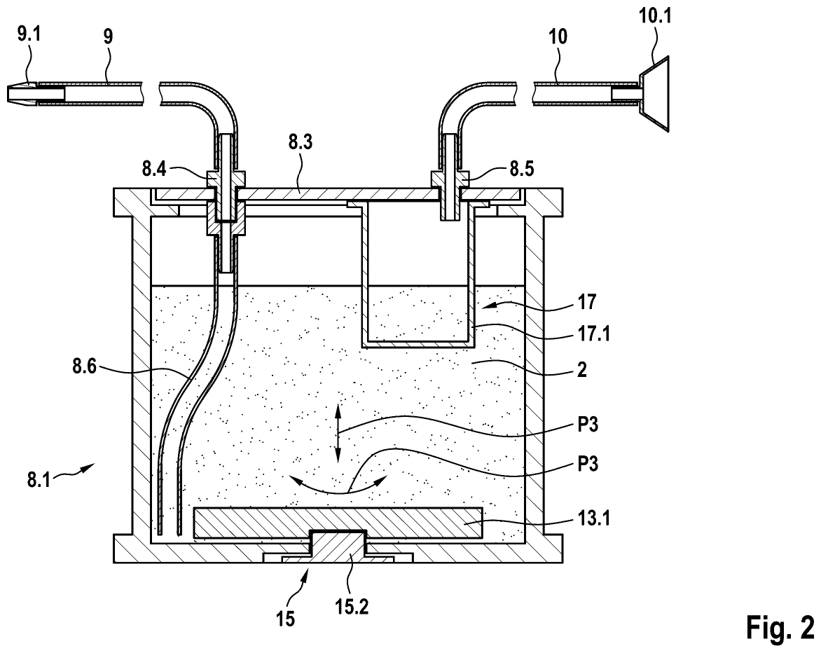

FIG. 2-6 each illustrate a principle drawing of a resin supply device in accordance with an exemplary embodiment; and

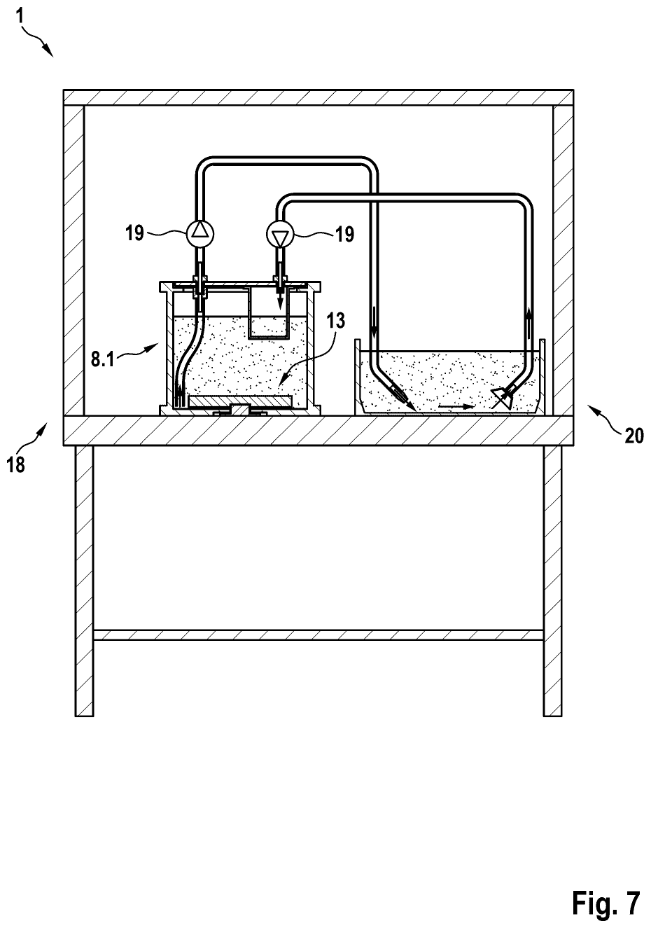

FIG. 7 illustrates a principle drawing of a cleaning station of an additive manufacturing apparatus in accordance with another exemplary embodiment.

FIG. 1 illustrates a principle drawing of an additive manufacturing apparatus 1 (“apparatus”) in accordance with an exemplary embodiment. The apparatus 1 is generally configured to additively manufacture a three-dimensional object (not shown) by photocuring a photocurable resin 2. Curing a photocurable resin 2 via the apparatus 1 typically, comprises a successive layerwise selective irradiation of the photocurable resin 2 with electromagnetic radiation 3 (light) emitted from an irradiation device 4, e.g. a digital light projector device, to successively generate respective cured resin layers of the three-dimensional object to be additively manufactured, wherein each cured resin layer represents a cross-section of the three-dimensional object to be additively manufactured.

The apparatus 1 comprises a vat device 5. The vat device 5 delimits a vat volume 5.1 for receiving the photocurable resin 2. The vat device 5 can comprise one or more vat device elements at least some of them forming a wall of the vat device 5 which is arranged and/or oriented to delimit the vat volume 5.1 for receiving the photocurable resin 2. The bottom of the vat volume 5.1 can be defined by a membrane 6 which is transmissive to the electromagnetic radiation 3 emitted from the irradiation device 4. The membrane 6 thus, has transmissive properties at least with respect to the electromagnetic radiation emitted from the irradiation device 4. The membrane 6 can thus, be built from an elastic and/or flexible polymer or a polymer structure which is transparent (at least with respect to the properties, e.g. wavelength, of the electromagnetic radiation 3 emitted from the irradiation device 4).

The apparatus 1 further comprises a build platform device 7 which comprises a build platform 7.1. The build platform 7.1 defines a build surface 7.2 on which a three-dimensional object can be additively manufactured. The build surface 7.2 typically, comprises a plane surface facing the membrane 6. As is indicated by double-arrow P1 in FIG. 1, the build platform 7.1 is moveably supported relative to the vat device 5 in at least one degree of freedom of motion. In the exemplary embodiments of the Fig., the at least one degree of freedom of motion is a translatory freedom of motion along a translatory axis A1. The translatory axis A1 is arranged and oriented, respectively perpendicular relative to the base plane of the vat device 5. The build platform device 7 can comprise one or more actuators (not shown), such as one or more electromotors, configured to effect motions of the build platform 7.1 relative to the vat device 5 along the translatory axis A1. The one or more actuators can be particularly, configured to effect reciprocal motions of the build platform 7.1 along the translatory axis A1; the build platform 7.1 can thus, be moved in two directions, e.g. upward and downward, along the translatory axis A1.

In the exemplary embodiments of the Fig., the build platform 7.1 is arranged above the vat device 5. The apparatus 1 thus, has a so-called bottom-up configuration which comprises that the build platform 7.1 is arranged above the vat device 5 and the irradiation device 4 is arranged below the vat device 5. However, the apparatus 1 could also generally have a so-called top-down configuration.

Although not shown in the Fig., the apparatus 1 could also comprise at least two different irradiation devices 4. In an exemplary configuration of the apparatus 1 with at least two different irradiation devices 4, a first irradiation device 4 can be or comprise a digital light projector device and a second irradiation device 4 can be or comprise a laser device. The at least two different irradiation devices 4 can be configured to emit electromagnetic radiation of (substantially) the same wavelength or of similar wavelength.

The apparatus 1 can generally comprise one or more optical devices (not shown) assigned to the one or more irradiation devices 4. Respective optical devices can be arranged in the optical path between the one or more irradiation devices 4 and the vat device 5. Respective optical devices can comprise at least one of: a beam combining device, a collimating device, an expanding device, a focusing device, a polarizing device, a beam splitting device, etc.

The apparatus 1 further comprises a resin supply device 8 at least configured to supply photocurable resin 2 from a resin container 8.1 to the vat device 5. The resin supply device 8 thus, generally provides a fluid connection implemented via at least one resin supply line 9, 10, between the resin container 8.1 and the vat device 5 which fluid connection at least enables that photocurable resin 2 can be conveyed from the resin container 8.1 to the vat device 5. Thus, the resin supply device 8 comprises at least one resin supply line 9, 10 extending between the resin container 8.1 and the vat device 5. A respective resin supply line 9, 10 can be built by or comprise a hose, tube, or pipe, for instance. Particularly, a respective resin supply line 9, 10 can be built by or comprise a flexible hose, tube, or pipe. A respective resin supply line 9, 10 can be provided with nozzle elements 9.1, 10.1 at their respective free ends, particularly the free ends assigned to the vat device 5.

The resin supply device 8 thus, forms basis for implementing a resin supply system within the apparatus 1 which can implement an internal resin recirculation and/or resin recycling. As will be apparent from further below, the resin supply device 8 can thus, form the basis for implementing a resin supply cycle or loop, particularly a closed resin supply cycle or loop, within the apparatus 1.

As is apparent from the above, the resin supply device 8 comprises at least one resin container 8.1. The resin container 8.1 delimits a container volume 8.2 for receiving a photocurable resin 2. The resin container 8.1 can comprise one or more walls, e.g. one or more bottom walls, one or more side walls, one or more top walls, which commonly delimit the container volume 8.2 (see also FIG. 2-6) . If the resin container 8.1 comprises two or more wall elements, the wall elements are connected with each other so as to do delimit the container volume 8.2. The connection of the wall elements can be a chemically and/or physically connection which can be achieved via, e.g. via clamping, screwing, riveting, gluing, soldering, welding, etc. One or more seal elements (not shown) can be provided between adjacent wall elements to avoid the possibility of leakage of photocurable resin 2 out of the container volume 8.2. At least one wall element can be moveably supported relative to at least one other wall element so as to be transferred in an open state in which access into the container volume 8.2 is possible, and in a close state, in which no access into the container volume 8.2 is possible. Hence, at least one wall element (see exemplary wall element 8.3 in FIG. 2) can be built as or comprise a lid element which enables eased filling or de-filling of the container volume 8.2 with a liquid, such as a photocurable resin or a cleaning agent. The one or more walls of the resin container 8.1 can be made from metal or plastic, for instance.

Also, composite materials, such as fiber composite materials, are conceivable. The one or more walls of the resin container 8.1 can at least partially be provided, e.g. via coating, spraying, etc., with one or more passivation layers configured to avoid possible (undesired) chemical and/or physical interactions between the one or more wall elements and a photocurable resin inside the container volume 8.2.

As an example, the resin container 8.1 can have a rotationally symmetric base shape, particularly a (hollow) cylindrical base shape, for instance. The resin container 8.1 can thus, have a bottle- or tank-like configuration, for instance. However, other basic shapes of the resin container 8.1 are generally contemplated.

As an example, the container volume 8.2 of the resin container 8.1 can be a volume of at least one of: 0.1 l, 0.2 l, 0.3 l, 0.4 l, 0.5 l, 0.6 l, 0.7 l, 0.8 l, 0.9 l, 1.0 l, 1.1 l, 1.2 l, 1.3 l, 1.4 l, 1.5 l, 1.6 l, 1.7 l, 1.8 l, 1.9 l, 2.0 l, 2.1 l, 2.2 l, 2.3 l, 2.4 l, 2.5 l, 2.6 l, 2.7 l, 2.8 l, 2.9 l, 3.0 l, 3.1 l, 3.2 l, 3.3 l, 3.4 l, 3.5 l, 3.6 l, 3.7 l, 3.8 l, 3.9 l, 4.0 l, 4.1 l, 4.2 l, 4.3 l, 4.4 l, 4.5 l, 4.6 l, 4.7 l, 4.8 l, 4.9 l, or 5.0 l, for instance.

As is apparent from FIG. 1, the resin supply device 8 further comprises at least one resin conveying device 11. The at least one resin conveying device 11 is generally configured to convey photocurable resin 2 from the at least one resin container 8.1 to the vat device 5. Particularly, the at least one resin conveying device 11 is configured to convey photocurable resin 2 out of the container volume 8.2, into at least one resin supply line 9, 10 extending between the resin container 8.1 and the vat device 5, and out of the at least one resin supply line 9, 10 into the vat volume 5.1 of the vat device 5. As such, the at least one resin conveying device 11 is configured to generate a stream (as indicated by the arrows in FIG. 1) of photocurable resin 2 from the resin container 8.1 to the vat device 5. Particularly, the at least one resin conveying device 11 is configured to generate a stream of photocurable resin 2 out of the container volume 8.2 of the resin container 8.1, into at least one resin supply line 11 extending between the resin container 8.1 and the vat device 5, through the at least one resin supply line 11, out of the at least one resin supply line 11, and into the vat volume 5.1 of the vat device 5.

Operation of the at least one resin conveying device 11 thus, particularly comprises generating a respective stream of photocurable resin 2 from the resin container 8.1 into the vat volume 5.1 of the vat device 5. Operation of the resin conveying device 11 can be controlled by a hardware- and/or software-implemented control unit (not shown) which is configured to generate control information for controlling operation of the at least one resin conveying device 11. Controlling operation of the at least one resin conveying device 11 can particularly, comprise controlling operational parameters of the at least one resin conveying device 11, such as conveying power, which influence the amount of photocurable resin, particularly the amount of photocurable resin per time, which is to be conveyed from the resin container 8.1 to the vat device 5. Controlling operation of the at least one resin conveying device 11 can be based on sensor information, e.g. indicative of a filling level or state of the vat device 5, which are provided by one or more sensors of the apparatus 1. As such, operation of the at least one resin conveying device 11 can be implemented as a control loop.

The at least one resin conveying device 11 can be built as or comprise at least one pump device. A respective pump device can be a peristaltic pump device. A peristaltic pump device, which can also be referred to as “roller pump”, is a positive displacement pump for conveying the photocurable resin 2 contained in a respective resin supply line 9, 10 showing elastic and/or flexible behavior. The resin supply line 9, 10 can be fitted inside a casing (not shown) of the pump which also comprises at least one rotor device (not shown) having a number of rotor elements, such as rollers, attached to its external circumference. During operation of the peristaltic pump, the rotor elements compress the resin supply line 9, 10 as they rotate which generates a compression resulting in a conveying motion of the photocurable resin 2 through the resin supply line 9, 10. Hence, the photocurable resin 2 will not be in chemical and/or physical contact with any component of the peristaltic pump such that the risk of contamination of the photocurable resin 2 is avoided or at least reduced.

As is apparent from FIG. 1, the vat device 5 and the resin container 8.1 can be arranged in two different chambers 12.1, 12.2 of a frame structure 12 of the apparatus 1. The frame structure 12 can comprise one or more frame structure elements 12.3 and/or one or more wall elements 12.4. As shown in FIG. 1, the frame structure 12 can define a first chamber 12.1 and at least one second chamber 12.2. The first chamber 12.1 can be separated from the second chamber 12.2 by at least one wall element 12.4. The respective wall element 12.4 can comprise a receiving portion for receiving the vat device 5. At least the build platform device 7 and/or the vat device 5 can be arranged in the first chamber 12.1 which can also be deemed an upper chamber or upper portion of the frame structure 12 or apparatus 1, respectively. At least the irradiation device 4 can be arranged in the second chamber 12.2 which can also be deemed a lower chamber or lower portion of the frame structure 12 or apparatus 1, respectively.

Notably, also the resin container 8.1 can be arranged in the second chamber 12.2. As such, a respective resin supply line 9, 10 can extend between the first chamber 12.1 and the second chamber 12.2 to provide a fluid connection between the resin container 8.1 arranged in the second chamber 12.2 and the vat device 5 arranged in the first chamber 12.1. Hence, the frame structure 12 can be provided with one or more passage structures 12.5, e.g. channels, openings, etc., for at least one resin supply line 9, 10 which facilitates that the at least one resin supply line 9, 10 can extend between the respective second chamber 12.2 and the respective first chamber 12.1, or vice versa, to provide at least one fluid connection between the resin container 8.1 and the vat device 5, or vice versa.

Although not explicitly shown in the Fig., the frame structure 12 can comprise attachment interfaces enabling a stable attachment of functional units of the apparatus 1, such as e.g. the vat device 1, the build platform device 7, and the at least one irradiation device 4. The frame structure 12 can thus, be deemed a machine frame of the apparatus 1.

The resin container 8.1 and/or the at least one resin conveying device 11 can be arranged in the second chamber 12 in a hanging or standing arrangement, for instance. The frame structure 12 can thus, comprise one or more attachment interfaces (not shown) for attaching e.g. the resin container 8.1 and/or the at least one resin conveying device 11 to the frame structure. Respective attachment interfaces can particularly, be provided with respective frame structure elements delimiting the second chamber 12.2 as specified above or with wall elements delimiting the second chamber 12.2.

Respective attachment interfaces can enable a detachable attachment of the resin container 8.1 and/or the at least one resin conveying device 11. Hence, attachment of at least one of the resin container 8.1 and/or the at least one resin conveying device 11 can be detachable so as to facilitate an exchange of the resin container 8.1 and/or the at least one resin conveying device 11, e.g. for service- and/or maintenance purposes.

It has been indicated above that the resin supply device 8 forms basis for implementing a resin supply system within the apparatus 1 which can implement an internal resin recirculation and/or resin recycling. Particularly, it has been indicated above that the resin supply device 8 can form the basis for implementing a resin supply cycle or loop, particularly a closed resin supply cycle or loop, within the apparatus 1.

The exemplary embodiment of FIG. 1 particularly, shows a configuration with a respective closed resin supply cycle or loop, which particularly facilitates internal resin recirculation and/or resin recycling. The resin supply cycle or loop at least comprises the resin container 8, the vat device 5, a first resin supply line 9 connecting the resin container 8 with the vat device 5, and a second resin supply line 10 connecting the vat device 5 with the resin container 8. In the exemplary configuration of FIG. 1, both the first resin supply line 9 and the second resin supply line 10 are provided with a resin conveying device 11.

As such, the resin container 8 can comprise an outlet portion 8.4 for connecting the first resin supply line 9 for a flow of photocurable resin 2 out of the resin container 8 with the vat device 5. The outlet portion 8.4 can be provided with a wall element 8.3, particularly with a top wall element or with a side wall element, of the resin container 8.1. The outlet portion 8.4 can be built as or comprise a connecting socket allowing a, particularly fluid-tight, connection of the resin container 8.1 with the first resin supply line 9.

The Fig. also show that the outlet portion 8.4 can be connected with an internal suction element 8.6, preferably arranged within an effective region of an agitating element 12.1, for removing photocurable resin 2 out of the container volume 8.2. The internal suction element 8.6 can be moveably supported within the container volume 8.2 so as to remove photocurable 2 resin from different locations inside the container volume 8.2. The internal suction element 8.6 can be built as or comprise a suction nozzle element, for instance.

Additionally, the resin container 8.1 can comprise an inlet portion 8.5 for connecting a second resin supply line 10 to enable a flow of resin flowing from the vat device 5 into the resin container 8.1. The inlet portion 8.5 can also be provided with a wall element 8.3, particularly with a top wall element or with a side wall element, of the resin container 8.1. The inlet portion 8.5 can be built as or comprise an inlet connecting socket allowing a, particularly fluid-tight, connection of the resin container 8.1 with the second resin supply line 10.

As is particularly, apparent from FIG. 2-6, the outlet portion 8.4 and the inlet portion 8.5 can be provided with a detachable wall element 8.3 of the resin container 8.1 which detachable wall element 8.3 is detachably attachable or attached to at least one other wall element of the resin container 8.1. The detachable wall element 8.3 can be built as or comprise a lid element of the resin container 8.1. Providing the outlet portion 8.4 and/or the inlet portion 8.5 with a lid element of the resin container 8.1 can improve installation and handling, for instance.

As mentioned before, a first resin conveying device 11 assigned to the first resin supply line 9 so as to generate a flow of resin flowing out of the resin container 8.1 into the vat device 5, and a second resin conveying device 11 assigned to the second resin supply line 19 so as to generate a flow of resin flowing out of the vat device 5 into the resin container 8.1 is provided. Hence, generating a first flow of photocurable resin 2 from the resin container 8.1 to the vat device 5 having first flowing properties, e.g. flowing velocity, and generating a second flow of photocurable resin 2 from the vat device 5 to the resin container 8.1 having second flowing properties, e.g. flowing velocity, is possible. The first and second flowing properties can be same or different such that a high degree of freedom with respect to filling and/or de-filling of the resin container 8.1 and/or the vat device 5 is possible, for instance.

As is particularly, apparent from FIG. 2-6, the apparatus 1 can further comprise an agitating device 13 configured to agitate the photocurable resin 2 provided in the container volume 8.2 of the resin container 8.1. As such, photocurable resin 2 in the container volume 8.2 of the resin container 8.1 can be agitated. Agitating the photocurable resin 2 in the container volume 8.2 of the resin container 8.1 can e.g. avoid possible undesired sagging and/or segregation effects of different chemical compounds of the photocurable resin 2. In other words, agitating the photocurable resin 2 in the container volume 8.1 of the resin container 8.1 can maintain and/or improve the properties of the photocurable resin 2 throughout one or more build processes.

The agitating device 13 can comprise at least one agitating element 13.1 arranged in the container volume 8.2 of the resin container 8.1. The at least one agitating element 13.1 can be moveable supported in at least one degree of freedom of motion to create an agitating motion. The agitating motion can also be deemed a stirring motion. The at least one degree of freedom of motion of the at least one agitating element 13.1 can be a translational degree of freedom of motion along a translational axis (as exemplarily indicated by double-arrow P2 in FIG. 2), which can be a central or symmetry axis of the resin container 8.1. Alternatively or additionally, the at least one degree of freedom of motion of the at least one agitating element 13.1 can be a rotational degree of freedom of motion about a rotational axis (as exemplarily indicated by double-arrow P3 in FIG. 2), which can be a central or symmetry axis of the resin container 8.1. Also, combined motions of the at least one agitating element 13.1 in at least two different degrees of freedom of motion, e.g. in one or more translational degrees of freedom of motion and/or in one or more rotational degrees of freedom of motion, are conceivable.

As is further apparent from the Fig., the at least one agitating element 13.1 can generally have a longitudinal basic shape. Particularly, the at least one agitating element 13.1 can have a blade- or blade-like shape. A respective blade- or blade-like shape can comprise one or more effective agitating surfaces which result in an agitation of the photocurable resin 2 when the at least one agitating element 13.1 is in the agitating motion.

As is further apparent from the Fig., the dimensions of the at least one agitating element 13.1 can generally be adapted to the dimensions of the container volume 8.2 of the resin container 8.1. As an example, the container volume 8.2 can have specific cross-sectional dimensions, particularly a specific cross-sectional width. The longitudinal dimensions of the at least one agitating element 13.1 can be chosen under consideration of the specific cross-sectional dimensions of the container volume 8.2. As an example, the longitudinal dimensions of the at least one agitating element 13.1 can be at least 30%, particularly at least 40%, more particularly at least 50%, more particularly at least 60%, more particularly at least 70%, more particularly at least 80%, more particularly at least 90% of the specific cross-sectional dimensions of the container volume 8.2. In other words, the at least one agitating element 13.1 can occupy a significant amount of the specific cross-sectional dimensions of the container volume 8.2 which results in a highly effective agitating, particularly avoiding or at least reducing dead zones.

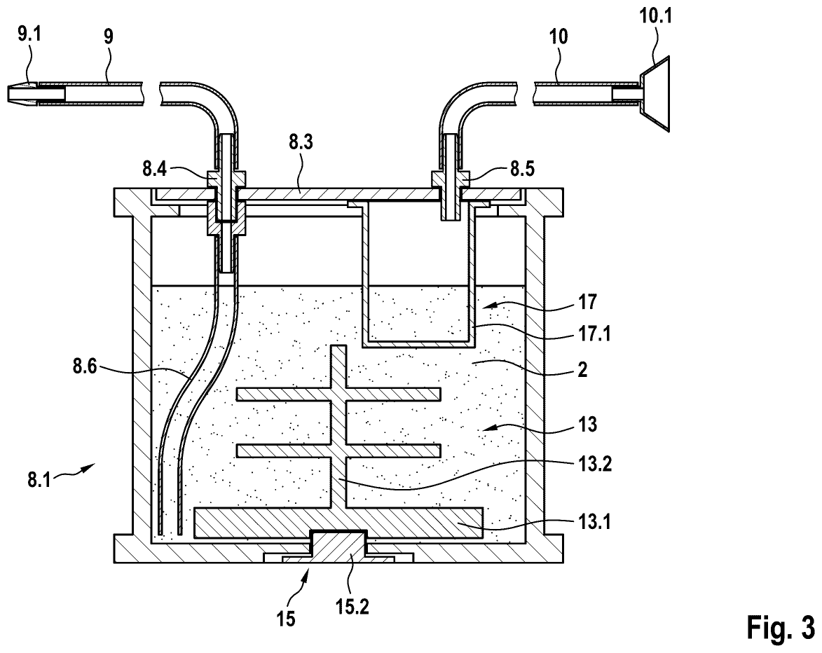

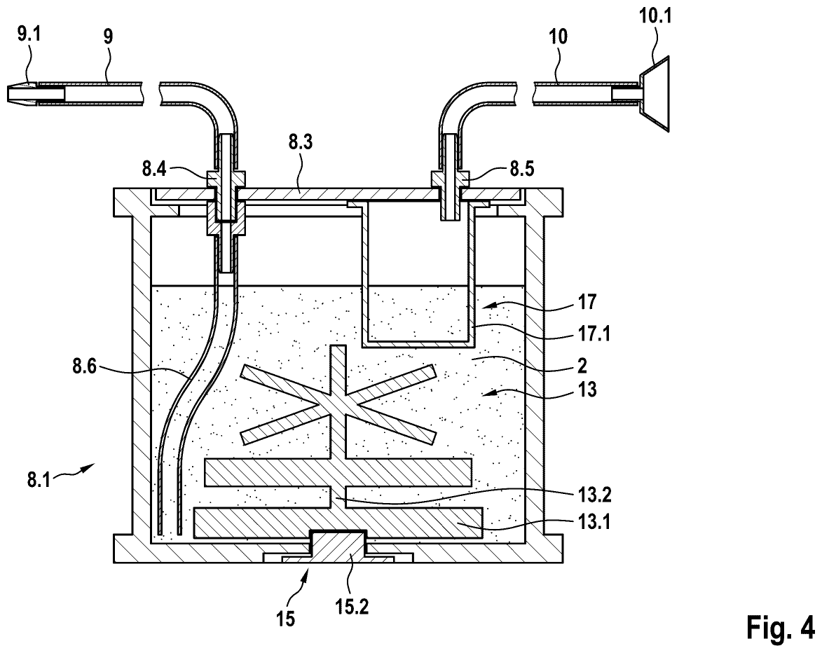

FIGS. 3 and 4 show exemplary configurations of an agitating device 13 with multiple agitating elements 13.1 to show that one or more first agitating elements 13.1 can have a first shape and/or first dimensions and one or more second agitating elements 13.1 can have a second shape and/or second dimensions, wherein the first and the second shape and/or dimensions can be the same or different.

FIGS. 3 and 4 also show that, the agitating device 13 can comprise a carrier structure 13.2, such as a carrier rod, which comprises attachment interfaces for attaching one or more agitating elements 13.1 thereto in one or more orientations and/or vertical positions. Multiple agitating elements 13.1 can thus, be arranged in a (vertically) stacked arrangement in different (vertical) planes, wherein at least one agitating element 13.1 is arranged in each plane.

In configurations with multiple agitating elements 13.1 such as exemplarily shown in FIGS. 3 and 4, one or more first agitating elements 13.1 can be moveable supported in at least one first degree of freedom of motion and one or more second agitating elements 13.1 can be moveable supported in at least one second degree of freedom of motion, wherein the first and the second degree of freedom of motion can be the same or different.

As is particularly, apparent from FIG. 1, the apparatus 1 can further comprise a drive device 14 couplable or coupled with the at least one agitating element 13.1 to exert a drive force and/or drive momentum on the at least one agitating element 13.1 so as to create a motion, particularly the agitating motion, of the at least one agitating element 13.1 in the at least one degree of freedom of motion. The drive device 14 can be built as or comprise at least one electric motor, such as a servomotor, for instance.

Operation of the drive device 14 can be controlled by a hardware- and/or software-implemented control unit (not shown) which is configured to generate control information for controlling operation of the drive device 14. Controlling operation of the drive device 14 can particularly, comprise controlling operational parameters of the drive device 14, such as drive power, which influence the intensity of the agitating motion, particularly the speed of the agitating motion per time, of the at least one agitating element 13.1. Controlling operation of the drive device 14 can be based on sensor information, e.g. indicative of an agitating state or level of the photocurable resin 2, which are provided by one or more sensors of the apparatus 1. As such, operation of the drive device 14 can be implemented as a control loop.

FIG. 1 shows that the drive device 14 can be external to the resin container 8.1 and couplable or coupled with the at least one agitating element 13.1 via at least one coupling device 15. As such, the drive device 14 can be a separate unit relative to the resin container 8.1. In such a manner, the constructive and/or functional configuration of the resin container 8.1 can be kept relatively simply because an integration of a drive device is not (necessarily) required.

FIG. 1 further shows that the coupling device 15 can comprise a first coupling element 15.1 operably coupled with the drive device 14 and a second coupling element 15.2 operably coupled with the at least one agitating element 13.1. The first coupling element 15.1 and the second coupling element 15.2 can be coupled, e.g. via corresponding engagement structures, such as thread structures, so as to transfer the drive force created by the drive device 14 to the at least one agitating element 13.1.

As is apparent from FIG. 1, the first coupling element 15.1 can be provided in a bottom region of the frame structure 12. Particularly, the first coupling element 15.1 can be provided in a bottom region of the second chamber 12.2. Likewise, the second coupling element 15.2 can be provided with a bottom region of the resin container 8.1. Such an arrangement of the first and second coupling element 15.1, 15.2 can not only ease coupling of the first coupling element 15.1 with the second coupling element 15.2 because the coupling can simply be achieved by arranging the resin container 8.1. in the bottom region of the frame structure 12 above the first coupling element 15.1, but also facilitates a highly integrated arrangement of the resin container 8.1 within the frame structure 12 of the apparatus 1.

Although not explicitly shown in the Fig., the apparatus 1 can comprise one or more dampening elements arranged between the resin container 8.1 and the frame structure 12. Respective dampening elements can be configured to dampen vibrations possibly caused by agitating motions of the at least one agitating element 13.1. Dampening respective vibrations can be of advantage because respective vibrations cannot negatively affect e.g. the operation the at least one irradiation device 4 which typically comprises several sensitive optical elements, such as lenses, for instance.

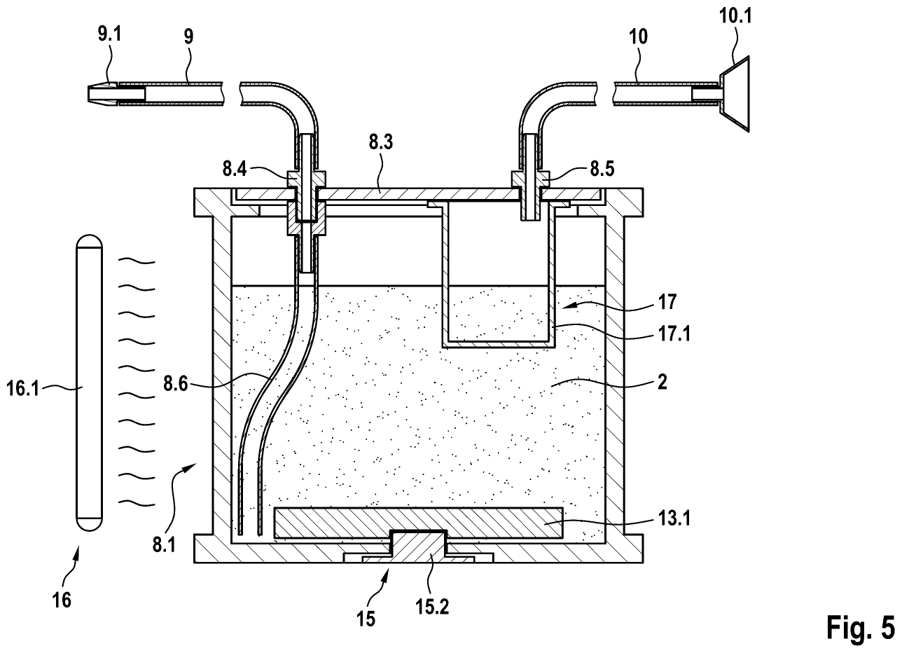

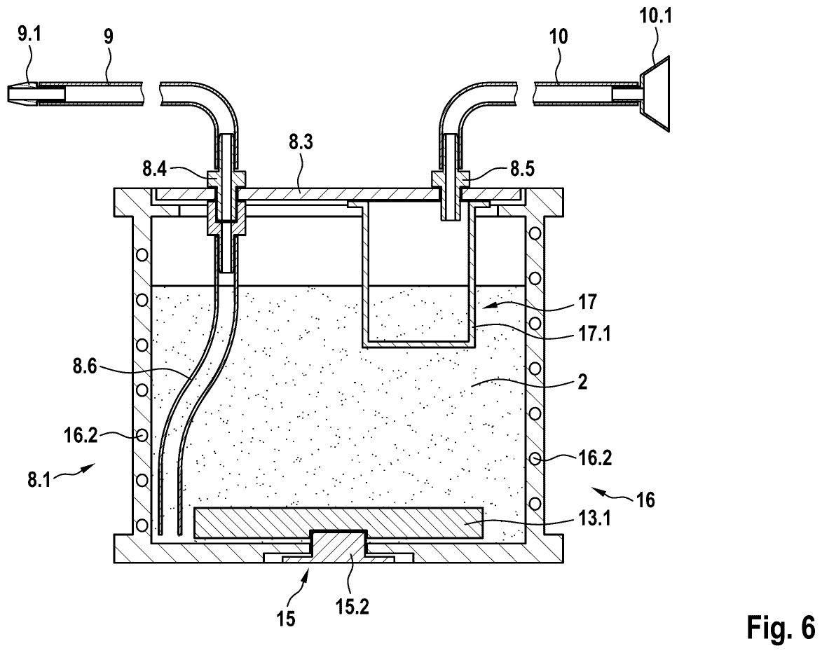

As is apparent from FIGS. 5, 6, the apparatus 1 can comprise a tempering device 16 configured to temper photocurable resin 2 in the container volume 8.2 and/or photocurable resin 2 in at least resin supply line 9, 10. The tempering device 16 can particularly, be configured to temper photocurable resin 2 in the container volume 8.2 and/or photocurable resin 2 in at least resin supply line 9, 10 with respect to a specific viscosity of the photocurable resin 2 and thus, with respect to a specific conveying and/or processing behavior of the photocurable resin 2. As such, tempering of the photocurable resin 2 via the tempering device 16 can generally comprise both cooling and/or heating the photocurable resin 2.

Operation of the at least one tempering device 16 can be controlled by a hardware- and/or software-implemented control unit (not shown) which is configured to generate control information for controlling operation of the tempering device 16. Controlling operation of the tempering device 16 can particularly, comprise controlling operational parameters of the tempering device 16, such as tempering power, which influence the amount of thermal energy provided to the photocurable resin 2. Controlling operation of the tempering device 16 can be based on sensor information, e.g. indicative of a temperature or a viscosity of the photocurable resin, which are provided by one or more sensors of the apparatus 1. As such, operation of the tempering device 16 can be implemented as a control loop.

As is exemplarily shown in FIG. 5, the tempering device 16 can comprise at least one tempering element 16.1 arranged outside the resin container 8.1. The at least one tempering element 16.1 can be configured to emit electromagnetic radiation, e.g. radio-frequency radiation, into the container volume 8.2 of the resin container 8.1 and/or into an inner volume of at least one resin supply line 9, 10. Tempering of the photocurable resin 2 can thus, be effected via electromagnetic radiation. As such, a respective tempering element 16.1 can comprise at least one emitter of electromagnetic radiation, particularly electromagnetic radiation of specific properties, e.g. a specific wavelength, which can be chosen under consideration of the absorption properties of the photocurable resin 2 to be tempered. Notably, the specific properties of the electromagnetic radiation are chosen such that only tempering and no curing of the photocurable resin 2 is effected.

As is exemplarily shown in FIG. 6, the tempering device 16 can comprise at least one tempering channel structure 16.2 arranged at or in at least one wall element of the resin container 8.1, wherein the at least one tempering channel structure 16.2 is configured to receive a flow of at least one tempering medium. The tempering channel structure 16.2 can comprise one or more tempering channels extending in one or more spatial directions and/or spatial planes. As such, one or more wall elements of the resin container 8.1 can be tempered by having a tempering medium, e.g. a cooled or heated fluid, stream through the tempering channel structure 16.2 arranged at or in at least one wall element of the resin container 8.1. In such a manner, a conductive and convective tempering of the photocurable resin 2 is possible which avoids any direct contact between the tempering medium and the photocurable resin 2.

Although not shown in the Fig., the same principles can apply to the wall elements of a respective resin supply line 9, 10. As such, the tempering device 16 can comprise at least one tempering channel structure 16.2 arranged at or in at least one wall element of the at least one resin supply line 9, 10, wherein the at least one tempering channel structure is configured to receive a flow of at least one respective tempering medium.

As is particularly apparent from FIG. 2, the apparatus 1 can further comprise at least one filtering device 17 configured to filter particulate elements, e.g. impurities, residues, etc., within the photocurable resin from a flow of photocurable resin flowing out of the resin container 8.1 and/or from a flow of photocurable resin flowing into the resin container 8.1. The filtering device 17 can comprise a selectively permeable wall, e.g. made from a material which is non-reactive with the photocurable resin. The material can comprise openings, e.g. of a size between 50-200 μm, for instance. which can be permeable only for photocurable resin and not for respective residues. The filtering device 17 can particularly, be configured to filter particulate elements from the photocurable resin 2 before they enter the vat device 5 and/or the container volume 8.2 such that a specific degree of purity of the photocurable resin 2 can be maintained. The filtering device can be an active filtering device, i.e. a filtering device having an actively controllable filtering activity, and/or a passive filtering device, i.e. a filtering device having no actively controllable filtering activity.

Operation of an active filtering device 17 can be controlled by a hardware- and/or software-implemented control unit (not shown) which is configured to generate control information for controlling operation of the active filtering device. Controlling operation of the active filtering device can particularly, comprise controlling operational parameters of the active filtering device, such as filtering power, which influence the filtering efficiency. Controlling operation of the active filtering device can be based on sensor information, e.g. indicative of a degree of undesired residues in the photocurable resin 2, which are provided by one or more sensors of the apparatus 1. As such, operation of the an active filtering device can be implemented as a control loop.

The at least one filtering device 17 can comprise at least one filtering element 17.1, e.g. a screening or sieving element, arranged in the at least one resin container 8.1 and/or in at least one connecting element 9, 10. The at least one filtering element 17.1 can enable a chemical and/or physical filtering of respective undesired residues from the photocurable resin 2. As such, the at least one filtering element 17.1 can comprise one or more chemical and/or physical interfaces which are configured to hinder undesired residues from passing through the at least one filtering element 17.1, for instance. Respective chemical and/or physical interfaces can be provided as or with respective openings as indicated above.

As mentioned before, the apparatus 1 can comprise a hardware- and/or software-implemented control unit configured to control operation of the at least one resin conveying device 11. The control unit can be particularly, configured to control operation of the at least one resin conveying device 11, particularly a first resin conveying device 11 assigned to the first resin supply line 9, so as to implement a first resin conveying mode in which photocurable resin is supplied from the resin container 8.1 to the vat device 5. Further, the control unit can be configured to control operation of at least one resin conveying device 11, particularly a second resin conveying device 11 assigned to the second resin supply line 10, so as to implement a second resin conveying mode in which photocurable resin is supplied from the vat device 5 to the resin container 8.1. As such, a recirculation of photocurable resin 2 within the apparatus 1 can be facilitated by a concerted control of respective first and/or second resin conveying devices 11.

Further, the control unit can be configured to control operation of at least one resin conveying device 11 so as to implement a cleaning mode in which a cleaning agent, e.g. a cleaning fluid comprising alcohol, is supplied from the resin container 8.1 to the vat device 5 and/or vice versa. As such, the configuration of the apparatus 1 also facilitates an improved cleaning of the apparatus 1, particularly to remove photocurable resin 2 from the apparatus 1, which can e.g. be required when the apparatus 1 is to be operated with chemically different photocurable resins 2. Notably, the resin supply system of the apparatus 1 as specified above cannot only be used for conveying a photocurable resin 2 within the apparatus 1 but also for conveying a cleaning agent within the apparatus 1. Conveying a cleaning agent within the apparatus 1 can thus, result in that not only the vat device 5 but also other components comprised by the resin cycle or loop can be cleaned in automatable or automated manner.

The exemplary embodiment of FIG. 7 shows that the apparatus 1 can also comprise a cleaning station 18 for cleaning at least one resin container 8.1 and/or a vat device 5. The cleaning station 18 can at least comprise a cleaning agent supply (not shown) and at least one cleaning agent conveying device 19 configured to convey a cleaning agent into the container volume of the resin container 8.1 and/or into the vat volume 5.1 of a vat device 5. The cleaning station 18 may comprise a frame structure 20 which may be connected with the frame structure 12 of the apparatus 1 such that a functionally highly integrated configuration of the apparatus 1 is given. Alternatively, the frame structure 20 of the cleaning station 18 can be separate to the frame structure 12 of the apparatus 1 which enables to freely arrange the cleaning station 18 independent from the apparatus 1.

Although not shown in the Fig., the resin supply device 8 can comprise multiple resin containers 8.1. In a configuration with multiple resin containers 8.1, the resin supply device 8 can comprise at least one resin distribution device which is configured to selectively connect at least one resin container of the multiple containers 8.1 with the vat device 5 such that a fluid connection between the at least one resin container 8.1 of the multiple resin containers 8.1 and the vat device 5 is established, while at least one other resin container 8.1 of the multiple resin containers 8.1 is not connected with the vat device 5 such that no fluid connection between the at least one other resin container 8.1 of the multiple resin containers 8.1 and the vat device 5 is established.

The at least one resin distribution device can comprise one or more resin distribution elements which are configured to selectively establish a connection of at least one resin container 8.1 of the multiple resin containers 8.1 with the vat device 5 such that a fluid connection between the at least one resin container 8.1 of the multiple resin containers 8.1 and the vat device 5 is established. A respective resin distribution element can be built as or comprise a control valve element, for instance. A respective control valve element can be transferred in an open state in which a fluid connection between at least one resin container 8.1 and the vat device 5 is established, and in a closed state in which a fluid connection between the at least one resin container 8.1 and the vat device 5 is not established. A respective control valve element can be particularly, configured as a directional control valve element which enables selectively establishing a fluid connection of one specific resin container 8.1 of the plurality of resin containers 8.1 with the vat device 5.

Operation of the at least one resin distribution device and respective resin distribution elements, can be hardware- and/or software-implemented control unit (not shown) which is configured to generate control information for controlling operation of the at least one resin distribution device. Controlling operation of the at least one resin distribution device can particularly, comprise controlling transferring respective valve elements in their respective open or closed states so as to selectively establish fluid connections between at least one specific resin container 8.1 and the vat device 5.

In all exemplary embodiments, the apparatus 1 can be provided with a fill-level indicating device configured to provide an information indicative of a fill-level of photocurable resin 2 in the container volume 8.2 of at least one resin container 8.1. A respective fill-level indicating device can comprise one or more fill-level sensors configured to determine the fill-level of a photocurable resin 2 in the container volume 8.2 of at least one resin container 8.1. Respective fill-level sensors can be provided internal or external to the at least one respective resin container 8.1. Respective fill-level sensors can be built as or comprise acoustic sensors, electrical sensors, such as capacitive sensors, optical sensors, mechanical sensors, such as weight sensors, for instance.

In all exemplary embodiments, at least one resin container 8.1 can be provided with an information carrier, such as a barcode, QR-code, etc., which contains information about the photocurable resin 2 received in the container volume 8.2. Respective information can thus, be machine-readable information. Respective information can comprise current or future chemical and/or physical properties of the photocurable resin 2, for instance. Chemical and/or physical properties can thus, not only include the chemical composition and related material properties, such as viscosity, etc. of the respective photocurable resin 2 but also processing conditions, such as curing wavelength, etc.

The apparatus 1 shown in the Fig. enables implementing a method of operating an additive manufacturing apparatus which at least comprises a step of conveying, via at least one resin conveying device 11, a photocurable resin 2 and/or a cleaning agent from at least one resin container 8.1 into the vat device 5 and/or from the vat device 5 into at least one resin container 8.1.

The method can be particularly, implemented by a control of respective controllable devices of the apparatus 1 via respective assigned control units as specified above.

One or more features mentioned in context with a specific embodiment of the apparatus 1 can be combined with one or more features of at least one other embodiment of the apparatus 1.

1. An additive manufacturing apparatus for additively manufacturing a three-dimensional object by curing a photocurable resin, comprising:
a vat device delimiting a vat volume for receiving a photocurable resin;
a build platform device comprising a build platform being moveably supported relative to the vat device in at least one degree of freedom of motion;
at least one irradiation device configured to emit electromagnetic radiation to selectively and successively cure a photocurable resin provided in the vat volume to additively manufacture a three-dimensional object;
a resin supply device, the resin supply device configured to supply photocurable resin from at least one resin container to the vat device, the resin supply device comprising:
at least one resin container delimiting a container volume for receiving a photocurable resin, and
at least one resin conveying device configured to convey photocurable resin from the container volume to the vat device.

2. The additive manufacturing apparatus of claim 1, comprising a frame structure, wherein the at least one resin container and/or the at least one resin conveying device is arranged within the frame structure.

3. The additive manufacturing apparatus of claim 1, further comprising an agitating device configured to agitate photocurable resin provided in the container volume of the at least one resin container.

4. The additive manufacturing apparatus of claim 3, wherein the agitating device comprises at least one agitating element arranged in the container volume of the at least one resin container, the at least one agitating element being moveable supported in at least one degree of freedom of motion to create an agitating motion.

5. The additive manufacturing apparatus of claim 4, further comprising at least one drive device couplable or coupled with the at least one agitating element to exert a drive force and/or drive momentum on the at least one agitating element so as to create a motion of the at least one agitating element in the at least one degree of freedom of motion.

6. The additive manufacturing apparatus of claim 5, wherein the at least one drive device is external to the at least one resin container and being couplable or coupled with the at least one agitating element via at least one coupling device.

7. The additive manufacturing apparatus of claim 1, further comprising a tempering device configured to temper photocurable resin in the container volume of the at least one resin container and/or resin in at least one resin supply line connecting the at least one resin container with the vat device.

8. The additive manufacturing apparatus of claim 7, wherein the tempering device comprises at least one tempering element arranged outside the at least one resin container, the at least one tempering element being configured to emit electromagnetic energy, particularly radio-frequency, into the container volume of the at least one resin container and/or into an inner volume of the at least one resin supply line; or
wherein the tempering device comprises at least one tempering channel structure arranged at or in at least one wall element of the at least one resin container, wherein the at least one tempering channel structure is configured to receive a flow of at least one tempering medium.

9. (canceled)

10. The additive manufacturing apparatus of claim 1, further comprising at least one filtering device configured to filter particulate elements, e.g. residues, within the photocurable resin from a flow of photocurable resin flowing out of the at least one resin container and/or from a flow of photocurable resin flowing into the at least one resin container.

11. The additive manufacturing apparatus of claim 10, wherein the at least one filtering device comprises at least one filtering element, e.g. a sieving element, arranged in the at least one resin container and/or in at least one resin supply line connecting the at least one resin container with the vat device.

12. The additive manufacturing apparatus of claim 1, wherein the at least one resin container comprises at least one outlet portion for connecting a resin supply line for a flow of photocurable resin flowing out of the at least one resin container with the vat device and/or wherein the at least one resin container comprises at least one inlet portion for connecting a resin supply line a flow of photocurable resin flowing into the at least one resin container from the vat device.

13. The additive manufacturing apparatus of claim 1, wherein the at least one resin container comprises at least one outlet portion which is connected with the vat device via a first resin supply line for a flow of resin flowing out of the at least one resin container into the vat device, and wherein the at least one resin container comprises at least one inlet portion being connected with the vat device via a second resin supply line for a flow of resin flowing out of the vat device into the at least one resin container.

14. The additive manufacturing apparatus of claim 13, further comprising a first resin conveying device assigned to the first resin supply line so as to generate a flow of photocurable resin flowing out of the at least one resin container into the vat device, and a second resin conveying device assigned to the second resin supply line so as to generate a flow of photocurable resin flowing out of the at least one resin container into the vat device.

15. The additive manufacturing apparatus of claim 13, wherein the at least one outlet portion is connected with at least one internal suction element, preferably arranged within an effective region of the at least one agitating element, for removing resin out of the container volume of the at least one resin container.

15. The additive manufacturing apparatus of claim 13, wherein the at least one outlet portion and/or the at least one inlet portion is provided with a detachable wall element of the at least one resin container which detachable wall element is attachable or attached to at least one other wall element of the at least one resin container.

17. (canceled)

18. The additive manufacturing apparatus of claim 1, further comprising a control unit configured to control operation of the at least one resin conveying device wherein the control unit is configured to control operation of the at least one resin conveying device so as to implement a resin conveying mode in which photocurable resin is supplied from the at least one resin container to the vat device, particularly in a recirculation cycle.

19. The additive manufacturing apparatus of claim 1, further comprising a control unit configured to control operation of the at least one resin conveying device, wherein the control unit is configured to control operation of the at least one resin conveying device so as to implement a cleaning mode in which a cleaning agent, e.g. a fluid comprising alcohol, is supplied from the at least one resin container to the vat device and/or vice versa.

20. The additive manufacturing apparatus of claim 1, further comprising a cleaning station for cleaning the at least one resin container, the cleaning station at least comprising a cleaning agent supply and at least one cleaning agent conveying device configured to convey a cleaning agent into the container volume.

21. The additive manufacturing apparatus of claim 1, wherein the at least one resin container is provided with a fill-level indicating device configured to provide an information indicative of a fill-level of resin in the container volume.

22. The additive manufacturing apparatus of claim 1, wherein the at least one resin conveying device is built as or comprises a pump.

23-24. (canceled)
